(19) United States
(12) Patent Application Publication
(10) Pub. No.: US 2025/0008036 A1
(43) Pub. Date: Jan. 2, 2025

(54) SCANNING DEVICE AND IMAGE FORMING DEVICE

(71) Applicant: Zhuhai Pantum Electronics Co., Ltd., Zhuhai (CN)

(72) Inventor: Weiguang LAI, Zhuhai (CN)

(21) Appl. No.: 18/755,869

(22) Filed: Jun. 27, 2024

(30) Foreign Application Priority Data
Jun. 30, 2023 (CN) 202310800764.8

(51) Int. Cl. H04N 1/00; H04N 1/04

(52) U.S. Cl. CPC H04N 1/00652; H04N 1/00583; H04N 1/00588; H04N 1/00594; H04N 1/00705; H04N 1/00745; H04N 1/0464; H04N 2201/0454

(57) ABSTRACT

A scanning device and an image forming device are provided. The scanning device includes a control unit and an image detection unit. The control unit is used to control the scanning device to transport an original document at a first speed, and the image detection unit is used to detect a position where the original document reaches. When the image detection unit detects that a front end position of the original document reaches a first scanning preset position, the control unit controls the scanning device to transport the original document at a second speed smaller than the first speed. After the scanning is completed, when the image detection unit detects that a rear end position of the original document reaches a first scanning end position, the control unit controls the original document to be transported at the first speed and discharged.

### CROSS-REFERENCE TO RELATED APPLICATION

This application claims the priority of Chinese Patent Application No. 202310800764.8, filed on Jun. 30, 2023, the content of which is incorporated herein by reference in its entirety.

### TECHNICAL FIELD

The present disclosure generally relates to the field of scanning technology and, more particularly, relates to a scanning device and an image forming device.

### BACKGROUND

During a scanning process, a motor of a multifunctional printer or scanner operates at a fixed speed when picking up paper, feeding paper before scanning, transferring paper during scanning, or discharging paper after scanning. The time required for paper transportation, scanning, and discharge is too long. The scanning performance of the multifunction printer or scanner is reduced.

### SUMMARY

One aspect of the present disclosure provides a scanning device. The scanning device includes a control unit and an image detection unit. The control unit is used to control the scanning device to transport an original document at a first speed, and the image detection unit is used to detect a position where the original document reaches. When the image detection unit detects that a front end position of the original document reaches a first scanning preset position, the control unit controls the scanning device to transport the original document at a second speed smaller than the first speed. After the scanning is completed, when the image detection unit detects that a rear end position of the original document reaches a first scanning end position, the control unit controls the original document to be transported at the first speed and discharged.

Another aspect of the present disclosure provides a scanning device. The scanning device includes a control unit, an image detection unit, and a flipping unit. The control unit is used to control the scanning device to transport an original document at a first speed, the image detection unit is used to detect a position where the original document reaches, and the flipping unit is used to flip the original document when the original document reaches a first reverse position. When a double-sided scanning mode is activated and the image detection unit detects that a front end position of a first side of the original document reaches a third scanning preset position, the control unit controls the scanning device to transport the first side of the original document at a second speed smaller than the first speed. After finishing scanning the first side of the original document, when the image detection unit detects a rear end position of the first side of the original document reaches a second scanning end position, the control unit controls the scanning device to transport the first side of the original document at the first speed until detecting that the rear end position of the first side of the original document reaches the first reverse position. After the flipping unit flips the original document from the first side to the second side, the control unit controls the scanning device to transport the second side of the original document at the first speed until the image detection unit detects that a front end position of the second side of the original document reaches a third scanning preset position, and the control unit controls the scanning device to transport the second side of the original document at the second speed. After scanning the second side of the original document is finished, the original document is continuously transported, and, when the image detection unit detects a the rear end position of the second side of the original document reaches the second scanning end position, the control unit controls the scanning device to circulate and transport the original document at the first speed, until it is discharged the original document in a consistent state with the first side of the original document before scanning.

Another aspect of the present disclosure provides an image forming device. The image forming device includes a scanning device. The scanning device includes a control unit and an image detection unit. The control unit is used to control the scanning device to transport an original document at a first speed, and the image detection unit is used to detect a position where the original document reaches. When the image detection unit detects that a front end position of the original document reaches a first scanning preset position, the control unit controls the scanning device to transport the original document at a second speed smaller than the first speed. After the scanning is completed, when the image detection unit detects that a rear end position of the original document reaches a first scanning end position, the control unit controls the original document to be transported at the first speed and discharged.

Another aspect of the present disclosure provides an image forming device. The image forming device includes a scanning device. The scanning device includes a control unit, an image detection unit, and a flipping unit, the control unit is used to control the scanning device to transport an original document at a first speed;
the image detection unit is used to detect a position where the original document reaches;
the flipping unit is used to flip the original document when the original document reaches a first reverse position;
when a double-sided scanning mode is activated and the image detection unit detects that a front end position of a first side of the original document reaches a third scanning preset position, the control unit controls the scanning device to transport the first side of the original document at a second speed, wherein the second speed is smaller than the first speed;
after finishing scanning the first side of the original document, when the image detection unit detects a rear end position of the first side of the original document reaches a second scanning end position, the control unit controls the scanning device to transport the first side of the original document at the first speed until detecting that the rear end position of the first side of the original document reaches the first reverse position;
after the flipping unit flips the original document from the first side to the second side, the control unit controls the scanning device to transport the second side of the original document at the first speed until the image detection unit detects that a front end position of the second side of the original document reaches the third scanning preset position, and the control unit controls the scanning device to transport the second side of the original document at the second speed; and
after scanning the second side of the original document is finished, the original document is continuously transported, and, when the image detection unit detects a the rear end position of the second side of the original document reaches the second scanning end position, the control unit controls the scanning device to circulate and transport the original document at the first speed, until it is discharged the original document in a consistent state with the first side of the original document before scanning.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic diagram of an exemplary scanning device according to various disclosed embodiments of the present disclosure.

FIG. 2 illustrates a schematic diagram of ADF single-sided scanning according to various disclosed embodiments of the present disclosure.

FIG. 3 illustrates another schematic diagram of exemplary scanning device according to various disclosed embodiments of the present disclosure.

FIG. 4 illustrates a schematic flowchart of ADF single-sided scanning according to various disclosed embodiments of the present disclosure.

FIG. 5 illustrates another schematic diagram of exemplary scanning device according to various disclosed embodiments of the present disclosure.

FIG. 6 illustrates a schematic diagram of DADF double-sided scanning according to various disclosed embodiments of the present disclosure.

FIG. 7 illustrates a schematic flowchart of DADF double-sided scanning according to various disclosed embodiments of the present disclosure.

FIG. 8 illustrates another schematic flowchart of ADF single-sided scanning according to various disclosed embodiments of the present disclosure.

FIG. 9 illustrates another schematic flowchart of DADF double-sided scanning according to various disclosed embodiments of the present disclosure.

FIG. 10 illustrates another schematic diagram of exemplary scanning device according to various disclosed embodiments of the present disclosure.

FIG. 11 illustrates a schematic diagram of RADF double-sided scanning according to various disclosed embodiments of the present disclosure.

FIG. 12 illustrates a flowchart of RADF double-sided scanning according to various disclosed embodiments of the present disclosure.

FIG. 13 illustrates another schematic flowchart of RADF double-sided scanning according to various disclosed embodiments of the present disclosure.

FIG. 14 illustrates an schematic diagram of exemplary image forming device according to various disclosed embodiments of the present disclosure.

FIG. 15 illustrates another schematic diagram of exemplary image forming device according to various disclosed embodiments of the present disclosure.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like units. The embodiments disclosed herein are exemplary only. Other applications, advantages, alternations, modifications, or equivalents to the disclosed embodiments are obvious to those skilled in the art and are intended to be encompassed within the scope of the present disclosure.

It should be noted that the terms used in the embodiments of the present disclosure are only for the purpose of describing specific embodiments, and are not intended to limit the scope of the present disclosure. As used in the embodiments of the present disclosure and the appended claims, the singular forms such as “a”, “said” and “the” are also intended to include the plural forms unless the context clearly indicates otherwise.

It should be understood that the term “and/or” used in this specification is just for relationship description of related objects, indicating that there can be three kinds of relationships. For example, A and/or B, which can mean that A exists alone, A and B exist at the same time, and B exists alone. In addition, the character “/” in this specification generally indicates that the related objects are in an “or” relationship.

In embodiments of the present disclosure, the terms such as first, second, third, etc. may be used to describe numbers, etc., but these numbers should not be limited to these terms. These terms are only used to distinguish numbers from each other. For example, without deuniting from the scope of the embodiments of the present disclosure, the first number may also be called a second number, and similarly, the second number may also be called a first number.

Depending on the context, the word “if” as used herein may be interpreted as “when”, or “while”, or “in response to determining”, or “in response to detecting”. Similarly, depending on the context, the phrase “if determined” or “if detects (stated condition or event)” may be interpreted as “when determined” or “in response to determining” or “when (stated condition or event) is detected)” or “in response to detecting (a stated condition or event)”.

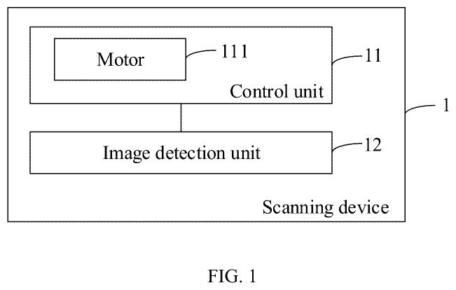

FIG. 1 is a schematic diagram of an exemplary scanning device according to various disclosed embodiments of the present disclosure. As shown in FIG. 1, the scanning device 1 may include a control unit 11, an image detection unit 12, and an image reading unit. The control unit 11 may be connected to the image detection unit 12. The control unit 11 may be configured to control the scanning device 1 to transport an original document at a first speed. The first speed may be higher than a rated transporting speed of the scanning device. The rated transporting speed may be a normal speed at which the motor drives the image reading unit to scan the original document. The rated transporting speed may be determined based on the performance of the scanning device 1 and usually set in advance. In the embodiments of the present disclosure, the rated transporting speed may be a second speed. The second speed may be less than the first speed. The image detection unit 12 may be configured to detect a position where the original document reaches. The original document may be a document file, a book, a recording medium such as paper, etc. In one embodiment, the image detection unit 12 may be a scanning sensor, which may be a photosensitive sensor or a mechanical sensor. When the image detection unit 12 with a photosensitive sensor senses that the light is blocked, the original document may be determined to reach a designated position. When the light is not blocked, the original document may be determined to leave the designated position. The image reading unit may be used to scan the original document, and may be a contact image sensor or a non-contact image sensor.

When the image detection unit 12 detects that a front end position of the original document reaches a first scanning preset position, the control unit 11 may control the scanning device 1 to transport the original document at the second speed, triggering the image reading unit to start scanning the original document. After the scanning is completed, when the image detection unit 12 detects that a rear end position of the original document reaches a first scanning end position, the control unit 11 may control the scanning device 1 to transport and discharge the original document at the first speed.

In one embodiment, the first scanning preset position may be the position where scanning starts, and the first scanning end position may be the position where scanning ends. The first scanning preset position and the first scanning end position may be the same position, or may be different positions.

It should be noted that the front end position and the rear end position may describe the positions where the original document reaches based on the transport direction. For example: In a double-sided scanning mode, when flipping the original document, the defined front end position of the first side of the original document may become the rear end position of the second side of the original document after flipping, and the defined rear end position of the first side of the original document may become the front end position of the second side of the original document after flipping.

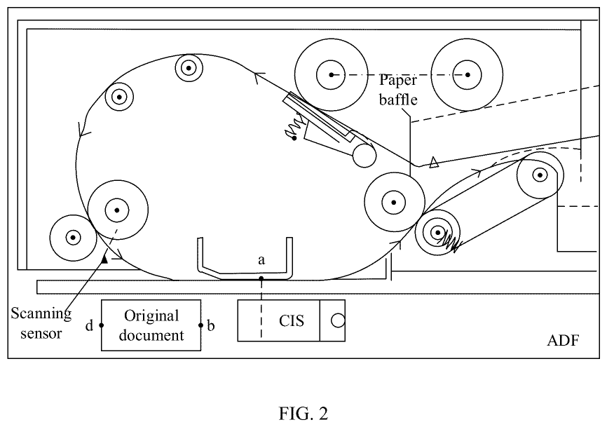

The scanning device may includes an automatic document feeder (ADF). FIG. 2 is a schematic diagram of ADF single-sided scanning according to various disclosed embodiments of the present disclosure. As shown in FIG. 2, in one embodiment, the ADF may include devices such as a paper baffle, a scanning sensor, and a contact image sensor (CIS). The curve with an arrow shown in FIG. 2 represents the paper path of the original document in the ADF. The ADF may also include a paper pick-up device and a motor. The paper pick-up device and the motor are not shown in the figure. The paper pick-up device may take out the original document from the paper tray. The original document may be transported by the motor through the paper baffle, the scanning sensor, CIS and other devices, and then may be discharged by the automatic document feeder.

As shown in FIG. 2, in one embodiment, the image detection unit 12 may include the scanning sensor. The first scanning preset position and the first scanning end position may be the same position. The first scanning preset position is represented by a point a, and the first scanning end position is also represented by the point a. A point b represents the front end position of the original document, and a point d represents the rear end position of the original document. The control unit 11 may include a motor. After the original document enters the ADF, the motor may quickly transport the original document at the first speed according to the transport path shown in FIG. 2, such that the original document quickly passes through the paper baffle and the scanning sensor, saving the transport time of the original document. The scanning sensor may detect in real time whether the point b at the front end of the original document reaches the point a. When the point b of the original document reaches the point a, the CIS may need to scan the content of the original document. To ensure the scanning quality, the control unit 11 may control the motor to drive the CIS to scan the original document at the second speed where the second speed is smaller than the first speed. The second speed may be related to the scanning speed of the CIS. For example, the second speed may be the default scanning speed, and the first speed may be larger than the scanning speed. Until the scanning sensor detects that the rear end position of the original document reaches the first scanning end position (that is, the first scanning preset position a), the CIS may end scanning. When the CIS finishes scanning the content of the original document, the control unit 11 may control the motor to switch from the second speed to the first speed to rapidly transport the original document until the original document is discharged, thereby saving transportation time and reducing the entire scanning time of the original document.

In the scanning device provided by the present disclosure, the original document may be no longer transported at a fixed speed throughout the whole process. Instead, the original document may be transported at different speeds. The original document may be transported at the first speed which is higher than the scanning speed before being scanned, and may be transported by switching from the first speed to the second speed which is the scanning speed when the original document is scanned. The quality of the scan may be ensured, and also the original document may be transported quickly when the original document does not need to be scanned, shortening the transportation time of the original document from paper feeding to scanning to paper discharge. The performance of the scanning device and the user experience may be improved.

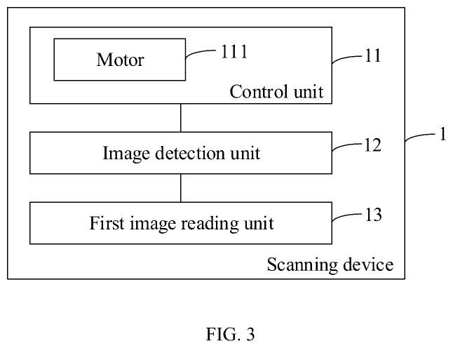

In another embodiment shown in FIG. 3 which shows another schematic diagram of exemplary scanning device, the scanning device 1 may further include a first image reading unit 13. the first image reading unit 13 is connected to the image detection unit 12.

When the user starts the single-sided scanning mode to scan the original document, the paper pick-up device may start acquiring the original document, and the control unit may transport the original document along the paper path at the first speed which is a high speed. Scanning may be started when the original document reaches a predetermined position, and the original document may be discharged along the paper path when scanning is completed. During the transportation process, when the image detection unit 12 detects that the front end position of the original document reaches the first scanning preset position, the first image reading unit may be triggered to start the scanning mechanism. At this time, the image detection unit 12 may send a first scanning start signal to the first image reading unit 13, and the first image reading unit 13 may respond to the first scanning start signal to scan the content of the original document at the second speed, that is, the scanning speed.

In the present embodiment, the image detection unit 12 may be used to determine in real time whether the front end position of the original document reaches the first scanning preset position. When it is determined that the front end position reaches the first scanning preset position, the original document may be determined to reaches the scanning region of the first image reading unit 13. The image detection unit 12 may send the first scanning start signal to the first image reading unit 13 and at the same time make the control unit 11 to control the motor to transport the original document at the second speed. While the first image reading unit 13 scans the content of the original document, the original document may be continuously transported at the second speed.

As shown in FIG. 2, the first image reading unit 13 may include a CIS. From starting the scan of the CIS when the point b of the original document reaches the point a to finishing the scan of the CIS when the point d of the original document reaches point a of the CIS, the motor may transport the original document at the second speed.

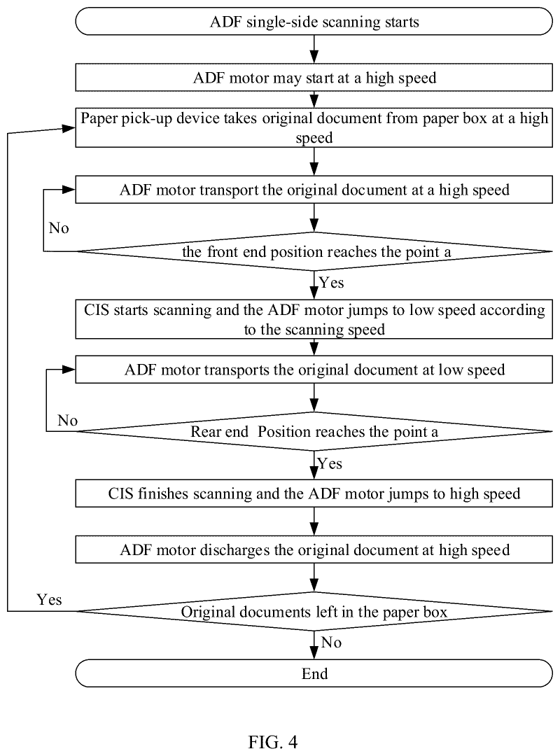

In one embodiment showin in FIG. 4 which is a flowchart of single-sided scanning based on ADF, in conjunction with FIG. 2, the motor may include an ADF motor. When the single-sided scanning mode is started, the ADF motor may start at the first speed which is a high speed, the paper pick-up device may pick up the original document from the paper tray at a high speed, and the ADF motor may be controlled to transport the original document at the first speed which is a high speed. The scanning sensor may determine whether the front end position of the original document reaches the point a. When the front end position does not reach point a, the ADF motor may be controlled continuously to transport the original document at high speed with the first speed until the scanning sensor detects that the front end position of the original document reaches the point a. When it is detected that the front end position of the original document reaches the point a, the CIS may start scanning. During scanning, the ADF motor may transport the original document at the second speed which is lower than the first speed. The scanning sensor may determine in real time whether the rear end position of the original document reaches the point a. When the rear end position does not reach the point a, the ADF motor may continue to be controlled to transport the original document at a low speed using the second speed, until the scanning sensor detects that the rear end position of the original document reaches the point a again. When the rear end position of the original document reaches the point a, the CIS may end scanning. At this time, the ADF motor may be controlled to switch to the high-speed operation, to transport the original document at the first speed until the original document is discharged at the high speed. The paper pick-up device may determine whether there are original documents left in the paper tray. When there are no original documents, the operation may end. When there are original documents left, the paper pick-up device may continue to pick up the original document s from the paper tray at high speed.

In one embodiment, the image detection unit 12 may detect that the rear end position reaches the first scanning end position, and then may send the first scanning end signal to the first image reading unit 13. In response to the first scanning end signal, the first image reading unit 13 may end scanning of the contents of the original document.

In the present embodiment, as shown in FIG. 2, the first scanning end position may be the point a. When the point d of the original document reaches the point a, the CIS may stop scanning the content of the original document, and then control the ADF motor to discharge the original document quickly with the first speed again, shortening the transport time.

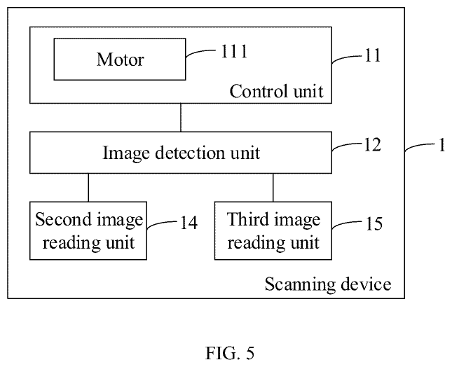

FIG. 5 shows schematic diagram of another scanning device provided by the present disclosure. The difference between FIG. 5 and FIG. 2 includes that: The scanning device shown in FIG. 2 includes only one image reading unit. In the embodiment shown in FIG. 5, the scanning device may include two image reading units. As shown in FIG. 5, in the present embodiment, the scanning device may include a second image reading unit 14 and a third image reading unit 15. The second image reading unit 14 may be connected to the image detection unit 12 and the third image reading unit 15 may be connected to the image detection unit 12. The second image reading unit 14 may be configured to scan the first side of the original document, and the third image reading unit 15 may be configured to scan the second side of the original document. The first side and the second side may be the front and back sides of the original document respectively. It should be noted that the second image reading unit 14 and the third image reading unit 15 are not limited to scanning the front and back side of the original document respectively. In another embodiment, the second image reading unit 14 may scan the second side of the original document and the third image reading unit 14 may scan the second side of the original document.

When the double-sided scanning mode is activated and the image detection unit 12 detects that the front end position of the first side of the original document reaches the first scanning preset position, a second scanning start signal may be sent to the second image reading unit 12 and the second image reading unit 14 may scan the content of the first side of the original document at the second speed in response to the second scanning start signal. When the image detection unit 12 detects that the front end position of the second side of the original document reaches the second scanning preset position, a third scanning start signal may be sent to the third image reading unit 15 and the third image reading unit 15 may scan the content of the second side of the original document at the second speed in response to the third scanning start signal.

In one embodiment, the double-sided scanning mode may be a double-sided simultaneous reading mode. This double-sided simultaneous reading mode means that both the second image reading unit 14 and the third image reading unit 15 may start scanning the corresponding side of the original document respectively when any side of the original document reaches the corresponding designated position. In one embodiment, the first scanning preset position may be a position where the second image reading unit 14 starts scanning, and the second scanning preset position may be a position where the third image reading unit 15 starts scanning. The image detection unit 12 may determine in real time whether the front end position of the first side of the original document reaches the first scan preset position or whether the front end position of the second side of the original document reaches the second scan preset position. When it is determined that the front end position of the first side reaches the first scanning preset position, the original document may be determined to reach the scanning area of the second image reading unit 14, and, the original document may be transported by switching from the first speed to the second speed while the image detection unit 12 sends the second scanning start signal to the second image reading unit 14. The second image reading unit 14 may scan the contents of the first side of the original document at the second speed. When the image detection unit 12 determines that the front end position of the second side of the original document reaches the second scanning preset position, the original document may be determined to reach the scanning area of the third image reading unit 15, and the third image reading unit 15 may scan the contents of the second side of the original document at the second speed.

The second image reading unit 14 and the third image reading unit 15 may be contact image sensors or non-contact image sensors.

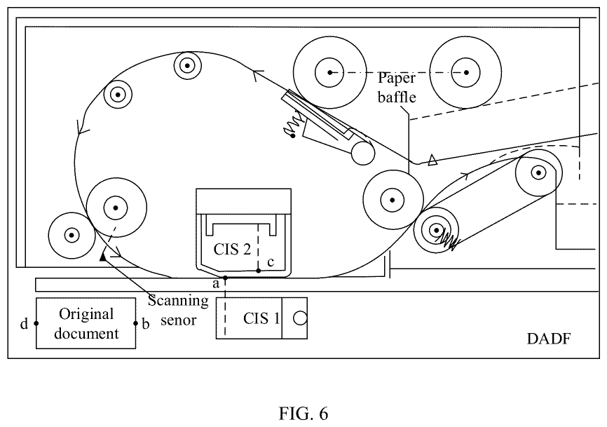

In one embodiment, the scanning device 1 may include a automatic duplex document feeder (DADF). FIG. 6 is a schematic diagram of DADF double-sided scanning. As shown in FIG. 6, the DADF may include devices such as a paper barrier, a scanning sensor, CIS 1 and CIS 2. The curve with an arrow shown in FIG. 6 represents the transportation route of the original document in the DADF. The DADF may also include a paper pick-up device and a motor. The paper pick-up device and motor are not shown in the figure. The paper pick-up device may take out the original document from the DADF paper tray, and the motor may transport the original document. The original document may be transported by the motor through the paper barrier, the scanning sensor, CIS 1 and CIS 2 and other devices, and then may be discharged by the automatic duplex document feeder.

As shown in FIG. 6, the image detection unit 12 may includes the scanning sensor; the second image reading unit 14 may includes the CIS 1, and the third image reading unit 15 may include the CIS 2. The first scanning preset position and the first scanning end position are not the same position. The point a represents the first scanning preset position, the point c represents the first scanning end position; the point b represents the front end position of the original document, and the point d represents the rear end position of the original document. The control unit 11 may include a motor. From the point b of the original document reaching the point a, until the point d of the original document reaching the point a, the CIS 1 may scan the content of the first side of the original document, and the motor may still transport the original document at the second speed. From the point b of the original document reaching the point c, until the point d of the original document reaching the point c, the CIS 2 may scan the content of the second side of the original document and the motor may still transport the original document at the second speed. When the point d of the original document reaches the point c, the motor may adjust the transport speed to the first speed.

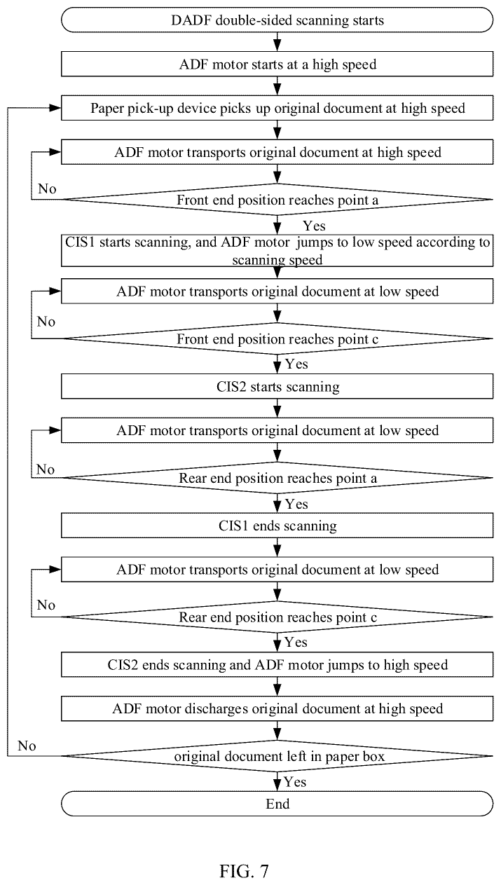

In one embodiment showin in FIG. 7 which is a flowchart of double-sided scanning based on DADF, in conjunction with FIG. 6, the motor may include an ADF motor. When the double-sided scanning mode is started, the ADF motor may start at the first speed which is a high speed, the paper pick-up device may pick up the original document from the paper tray at a high speed, and the ADF motor may be controlled to transport the original document at the first speed which is a high speed. The scanning sensor may determine whether the front end of the original document reaches the point a. When the front end position does not reach point a, the ADF motor may be controlled continuously to transport the original document at high speed with the first speed until the scanning sensor detects that the front end position of the original document reaches the point a. When it is detected that the front end position of the original document reaches the point a, the CIS 1 may start scanning, and the ADF motor may switch to a low speed according to the scanning speed and transport the original document at the second speed. The scanning sensor may determine in real time whether the front end position of the original document reaches the point c. When the front end position does not reach the point c, the ADF motor may continue to be controlled to transport the original document at a low speed using the second speed. When the the front end position reaches the point c, CIS 2 may start scanning, and the ADF motor may transport the original document at the second speed. The scanning sensor may determine in real time whether the rear end position of the original document reaches the point a. When the rear end position of the original document does not reach the point a, the ADF motor may continue to be controlled to transport the original document at a low speed using the second speed. When the rear end position of the original document reaches the point a, the CIS 1 may end scanning, and the ADF motor may continue to be controlled to transport the original document at a low speed using the second speed. The scanning sensor may determine in real time whether the rear end position of the original document reaches the point c. When the rear end position of the original document does not reach the point c, the ADF motor may continue to be controlled to transport the original document at a low speed using the second speed. When the rear end position of the original document reaches the point a, the CIS 2 may end scanning, and the ADF motor may be controlled to switch to the high-speed operation, to transport the original document at the first speed until the original document is discharged at the high speed. The paper pick-up device may determine whether there are original documents left in the paper tray. When there are no original documents, the operation may end. When there are original documents left, the paper pick-up device may continue to pick up the original documents from the paper tray at high speed.

In one embodiment, when the image detection unit 12 detects that the rear end position of the first side of the original document reaches the third scanning end position, the second scanning end signal may be sent to the second image reading unit 14, and the second image reading unit 14 may respond to the second scanning end signal to stop scanning the content of the first side of the original document. When the image detection unit 12 detects that the rear end position of the second side of the original document reaches the first scanning end position, the third scanning end signal may be sent to the third image reading unit 15, and the third image reading unit 15 may be configured to stop scanning the content of the original document in response to the third scan end signal.

In the present embodiment, as shown in FIG. 6, the third scanning end position may be the point a, and the first scanning end position may be the point c. When the point d of the original document reaches the point a, the CIS 1 may stop scanning the content of the first side of the original document. When the point d of the original document reaches the point c, the CIS 2 may stop scanning the second side of the original document, and the motor may quickly transport the original document at the first speed again, shortening the transportation time.

In one embodiment, the second image reading unit 14 and the third image reading unit 15 may be respectively disposed on the first side and the second side of the original document. The second image reading unit 14 and the third image reading unit 15 may be opposite to each other.

In one embodiment, the second image reading unit 14 and the third image reading unit 15 may be opposite and relatively offset to each other. As shown in FIG. 6, the position of the second image reading unit 14 may be in front of the position of the third image reading unit 15. Therefore, the position where the second image reading unit 14 starts scanning (i.e., the first scanning preset position point a) may be set in front of the position where the third image reading unit 15 starts scanning (i.e., the second scanning preset position point c). In the double-sided simultaneous reading mode, the first side and the second side of the original document may be scanned simultaneously by the second image reading unit 14 and the third image reading unit 15.

In another embodiment, the second image reading unit 14 and the third image reading unit 15 may be opposite and relatively aligned to each other. That is, the second image reading unit 14 may be located directly above the third image reading unit 15. Therefore, the position where the second image reading unit 14 starts scanning (that is, the first scanning preset position), and the position where the third image reading unit 15 starts scanning (that is, the second scanning preset position) may be the same. Also the position where the second image reading unit 14 ends scanning may be also the same as the position where the third image reading unit 15 ends scanning. Therefore, in the double-sided simultaneous reading mode, the first side and the second side of the original document may be synchronously and simultaneously scanned by the second image reading unit 14 and the third image reading unit 15. Compared with the offset setting of the second image reading unit 14 and the third image reading unit 15, the overall scanning time may be further shortened.

In one embodiment, the position of the second image reading unit 14 may be the position where the second image reading unit 14 performs scanning, and the position of the third image reading unit 15 may be the position where the third image reading unit 15 performs scanning. As shown in FIG. 6, the original document may be divided into two sides, and the CIS 1 and CIS 2 may be respectively distributed on two sides of the original document. Since the CIS 1 scans the original document first, the position of CIS 1 may be in front of the position of the CIS 2.

In one embodiment, as shown in FIG. 1, FIG. 3 or FIG. 5, the control unit 11 may include a motor 111. The motor 111 may be connected to the image detection unit 12.

When the image detection unit 12 detects that the front end position reaches the first scanning preset position, a first speed control signal may be sent to the motor 111, and the motor 111 may respond to the first speed control signal by changing the speed of transporting the original document from the first speed to the second speed.

In the present embodiment, the motor 111 may be configured to change the speed of transporting the original document from the first speed to the second speed in response to the first speed control signal; or to decrease the speed of transporting the original document from the first speed to the second speed in response to the first speed control signal.

The motor is not shown in either FIG. 2 or FIG. 6. The motor may drive the original document and transport the original document according to the transportation route shown in FIG. 2 or FIG. 6. The motor may include an ADF motor.

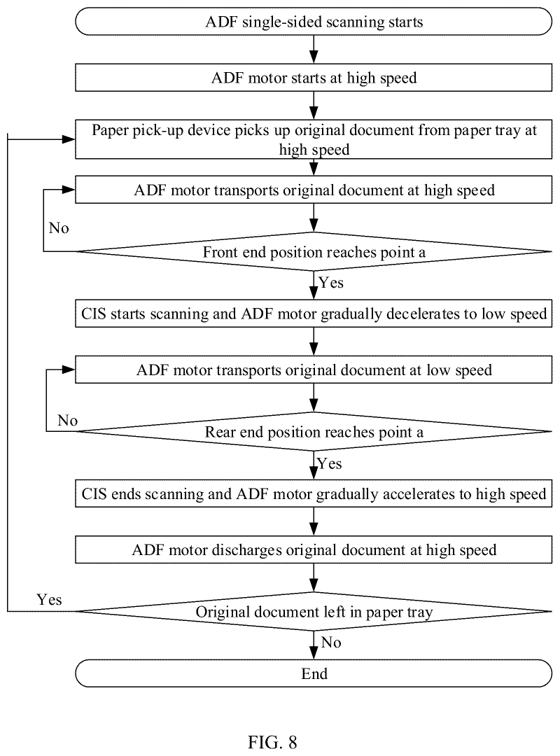

When the device includes the first image reading unit 13, in conjunction with FIG. 2, as shown in FIG. 4, the ADF motor may change to low-speed operation according to the scanning speed, which means that the ADF motor may directly reduce the speed of transporting the original document from the first speed to the second speed. The speed of the original document may jump from the first speed to the second speed without any deceleration process. FIG. 8 is a flowchart of another ADF-based single-sided scanning. As shown in FIG. 8, with reference to FIG. 4, the difference between FIG. 8 and FIG. 4 includes that: in the embodiment shown in FIG. 8, when the front end position of the original document reaches the point a, the ADF motor may decelerate to low-speed operation according to the scanning speed; and when the rear end position of the original document reaches the point a, the ADF motor may accelerate to high-speed operation. As shown in FIG. 8, the ADF motor may decelerate to low speed operation according to the scanning speed, which means that the ADF motor may gradually slow down the speed of transporting the original document from the first speed to the second speed, and the speed of the original document may gradually slow down from the first speed to the second speed with a deceleration process.

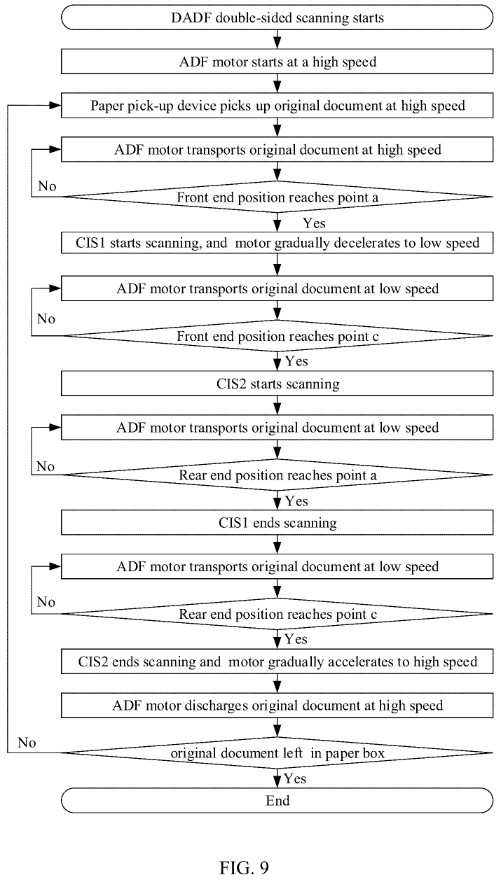

When the device includes the second image reading unit 14 and the third image reading unit 15, combined with FIG. 6 and FIG. 7, the ADF motor may change to low-speed operation according to the scanning speed, which means that the ADF motor may directly reduce the speed of transporting the original document from the first speed to the second speed. The speed of the original document may jump from the first speed to the second speed without any deceleration process. FIG. 9 is a flowchart of another DADF-based double-sided scanning. As shown in FIG. 9, with reference to FIG. 7, the difference between FIG. 9 and FIG. 7 includes that: in the embodiment shown in FIG. 9, when the front end position of the original document reaches the point a, the ADF motor may decelerate to low-speed operation according to the scanning speed; and when the rear end position of the original document reaches the point c, the ADF motor may accelerate to high-speed operation. As shown in FIG. 9, the ADF motor may decelerate to low speed operation according to the scanning speed, which means that the ADF motor may gradually slow down the speed of transporting the original document from the first speed to the second speed, and the speed of the original document may gradually slow down from the first speed to the second speed with a deceleration process.

In one embodiment, when the image detection unit 12 detects that the rear end position reaches the first scanning end position, a second speed control signal may be sent to the motor 111, and the motor 111 may respond to the second speed control signal by changing the speed of transporting the original document from the second speed to the first speed.

In the present embodiment, the motor 111 may be configured to change the speed of transporting the original document from the second speed to the first speed in response to the first speed control signal; or to accelerate the speed of transporting the original document from the second speed to the first speed in response to the first speed control signal.

When the device includes the first image reading unit 13, as shown in FIG. 4, when the rear end position of the original document reaches the point a, the ADF motor may change to high-speed operation according to the scanning speed, which means that the ADF motor may directly change the speed of transporting the original document from the second speed to the first speed. The speed of the original document may jump from the second speed to the first speed without any acceleration process. In another embodiment as shown in FIG. 8, when the rear end position reaches the point a, the ADF motor may accelerate to high-speed operation, which means that the ADF motor may gradually accelerate the speed of transporting the original document from the second speed to the first speed, and the speed of the original document may gradually increase from the second speed to the first speed with an acceleration process.

When the device includes the second image reading unit 14 and the third image reading unit 15, as shown in FIG. 7, when the rear end position of the original document reaches the point a, the ADF motor may change to high-speed operation according to the scanning speed, which means that the ADF motor may directly change the speed of transporting the original document from the second speed to the first speed. The speed of the original document may jump from the second speed to the first speed without any acceleration process. In another embodiment as shown in FIG. 9, when the rear end position reaches the point c, the ADF motor may accelerate to high-speed operation, which means that the ADF motor may gradually accelerate the speed of transporting the original document from the second speed to the first speed, and the speed of the original document may gradually increase from the second speed to the first speed with an acceleration process.

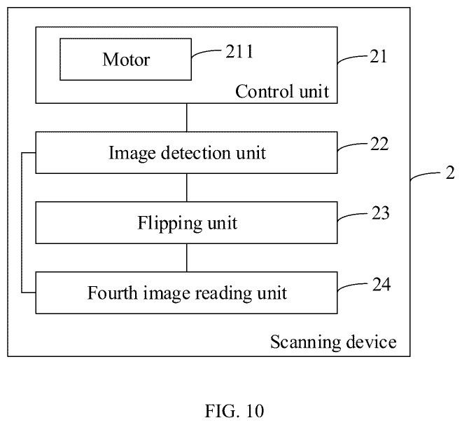

In another embodiment shown in FIG. 10 which is a schematic diagram of another scanning device provided by the present disclosure, the scanning device 2 may include a control unit 21, an image detection unit 22, and a flipping unit 23. The image detection unit 22 is connected to the control unit 21 and the flipping unit 23. The difference between the scanning device 2 in the present embodiment from the scanning device 1 shown in FIG. 6 includes that the scanning device 2 in the present embodiment may include one image reading unit and the flipping unit 23 for flipping the original document. The flipping unit 23 may flip the original document when detecting that the original document reaches a designated position, such as a first reverse position in the scanning device 2.

When the double-sided scanning mode is activated, the control unit 21 may control the scanning device 2 to transport the original document at the first speed. When the image detection unit 22 detects that the front end position of the first side of the original document reaches the third scanning preset position, the control unit 21 may control the scanning device 2 to transport the original document at the second speed. The second speed may be lower than the first speed. After the scanning of the first side of the original document is completed, when the image detection unit 22 detects that the rear end position of the first side of the original document reaches the second scanning end position, the control unit 21 may control the scanning device 2 to transport the first side of the original document at the first speed until detecting that the rear end position of the first side of the original document reaches the first reverse position and control the flipping unit 23 to flip the original document for the first time, such that the second side of the original document is placed upward. Subsequently, the control unit 21 may control the scanning device 2 to continue transporting the second side of the original document at the first speed until the image detection unit 22 detects that the front end position of the second side of the original document reaches the third scanning preset position, and the control unit 21 then may control the scanning device 2 to switch to the second speed to transport the original document. At this time, scanning of the second side of the original document at the second speed may be started. After the scanning of the second side of the original document is completed and the image detection unit 22 detects that the rear end position of the second side of the original document reaches the second scanning end position, the control unit 21 may control the scanning device 2 to switch to the first speed and continue to circulate and transport the original document until the original document is discharged in the first speed. That is, the original document may be discharged in its initial state to keep it consistent with the initial state of the original document before scanning. For example, the user may place the original document and the back side of the original document may be used as the first side, and then the double-sided scanning mode may be started. After scanning and flipping, the discharge may be still consistent with the back side of the original document as the first side. That is, what the original document looks like when it is discharged may be what it will look like when it is placed.

Therefore, after the second side of the original document is scanned, to keep the discharged original document consistent with the state before scanning, the second side of the original document may need to be flipped again such that the first side of the original document is output as the front side. Therefore, after the rear end position of the second side of the original document reaches the second scanning end position, when the control unit 21 controls the scanning device 2 to transport the original document at the first speed to the first reverse position, the flipping unit 23 may flip the second side of the original document for the second time, such that the first side of the original document is used as the front side and the original document is still transported and discharged at the first speed. After the flipping unit 23 flips the original document for the second time, since both the first side and the second side of the original document have been scanned, the image detection unit 22 may not detect the position of the original document, and may also not scan the first side and the second side of the original document for the second time. Therefore, from the second flipping of the original document to the discharging of the original document, the control unit 22 may always control the original document to be transported and discharged at a high speed at the first speed. Therefore, user habits may be maintained and user experience may be improved. The case that the original document is placed in the front-side for scan by users and are placed in the back side after scanning may be avoided. Also, after the first and second sides are scanned, the original document may be transported at full high-speed, further shortening the scanning time and improving efficiency.

In one embodiment, the third scanning preset position may be the position where scanning starts, the second scanning end position may be the position where scanning ends, and the first reverse position may be the position where the original document is flipped.

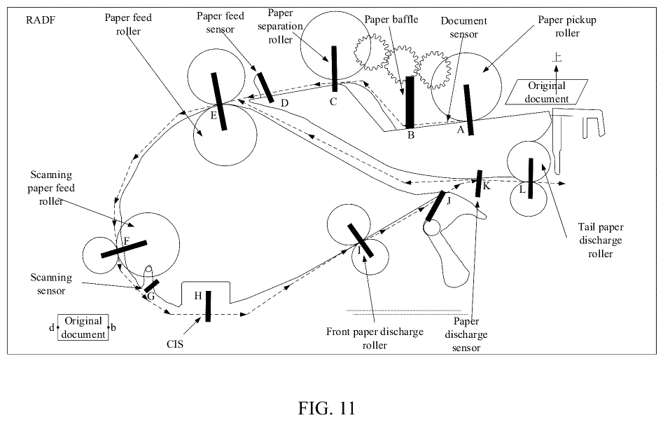

In one embodiment, the scanning device may include a reversing automatic document feeder (RADF). FIG. 11 is a schematic diagram of a RADF double-sided scanning provided by one embodiment of the present disclosure. As shown in FIG. 11, the RADF may include a paper pick-up roller, a document sensor, a paper blocking piece, a paper separation roller, a paper feed sensor, a paper feed roller, a scanning paper feed roller, a scanning sensor, a CIS, a front paper discharge roller, a paper discharge sensor, a tail paper discharge roller, and other devices. The curve with arrows shown in FIG. 11 represents the transportation route of the original document in the RADF. The point A represents the position of the paper pick-up roller; the point B represents the position of the paper blocking piece; the point C represents the position of the paper separation roller; the point D represents the position of the paper feed sensor; the point E represents the position of the paper feed roller; the point F represents the position of the scanning paper feed roller; the point G represents the position of the scanning sensor; the point H represents the third scanning preset position, which may also represent the second scanning end position and also the position where the CIS starts scanning or ends scanning; the point I represents the position of the front paper discharge roller; the point K represents the position of the paper discharge sensor; the point L represents the position of the tail paper discharge roller. The original document may be taken out from the ADF tray, transported by the motor, and pass through the paper pick-up roller, the document sensor, the paper blocking piece, the paper separation roller, the paper feed sensor, the paper feed roller, the scan feed roller, the scan sensor, tge CIS, the front paper discharge roller, the paper discharge sensor and the tail paper discharge roller, to be discharged by the RADF.

As shown in FIG. 11, the upward side of the original document shown in FIG. 11 may be the first side, and the downward side may be the second side. The control unit 21 may include a motor which is not shown in FIG. 11, and the image detection unit 22 may include a paper feed sensor, a scanning sensor, and a paper discharge sensor. The third scanning preset position and the second scanning end position may be the same. The point H represents the third scanning preset position, and also represents the second scanning end position. The point K represents the first reverse position, the point b represents the front end position of the original document, and the point d represents the rear end position of the original document. When the RADF scans the original document on both sides, the motor may be controlled to quickly transport the original document at the first speed in the order of points A, B, C, D, E, F, and G; and the scanning sensor may detect in real time whether the point b reaches the point H. When the point b reaches the point H, the CIS may need to scan the front content of the original document. To ensure the scanning quality, the motor may transport the original document at the second speed. The second speed may be smaller than the first speed, and the second speed may be related to the scanning speed of the CIS. The scanning sensor may detect in real time whether the point d reaches the point H. When the point d of the original document reaches the point H, the CIS may end scanning the contents of the original document, and the motor may quickly transport the original document at the first speed in the order of the points I, J, and K. The point K may be used as the first reverse position. When the point d of the original document passes through the point K, the flipping unit may flip the original document, and the motor may quickly transport the flipped original document at the first speed, such that the original document passes quickly through the points K, E, F, and G. The scanning sensor may detect in real time whether the point b reaches the point H. When the point b reaches the point H, the CIS may need to scan the content of the reverse side of the original document, and the motor may transport the original document at the second speed. The scanning sensor may detect in real time whether the point d reaches the point H. When the point d of the original document reaches the point H, the CIS may end scanning the content of the original document and control the motor to quickly transport the original document at the first speed in the order of the points I, J, and K. When the point d of the original document reaches the point K, the flipping unit may flip the original document again. After the original document is turned back to the front, the motor may quickly transport and discharges the original document turned back to the front at the first speed in the order of the points K, E, F, G, H, I, J, K, L. Therefore, double-sided scanning of the original document may be achieved. When multiple original documents with consecutive page numbers need to be scanned, the RADF loops through the steps of double-sided scanning of the original documents, such that the order of the original documents is not changed and the page numbers remain continuous when the multiple original documents are discharged.

In the scanning device provided by the present disclosure, the scanning device may include the control unit, the image detection unit, and the flipping unit. When the double-sided scanning mode is activated, the control unit may be configured to transport original document at the first speed; and when the image detection unit detects that the front end position of the original document reaches the third scanning preset position, the control unit may transport the original document at the second speed. The second speed may be lower than the first speed. After the first side of the original document is scanned, when the image detection unit detects that the rear end position of the original document reaches the second scanning end position, the control unit may transport the original document at the first speed. The flipping unit may flip the original document when the image detection unit detects that the rear end position reaches the first reverse position. The image detection unit may be also used to control the control unit to transport the original document at the second speed when it detects that the front end position reaches the third scanning preset position. After the second side of the original document is scanned, the image detection unit may be also used to control the control unit to transport the original document at the first speed when it is detected that the rear end position reaches the second scanning end position, and to control the flipping unit to flip the original document when it is detected that the rear end position reaches the first reverse position. When the multiple original documents are discharged, the page numbers may be continuous. The original document may be transported at a low speed when being scanned, ensuring the quality of scanning. And, the original document may be transported quickly when it does not need to be scanned, which increases the transportation speed of the original document and shortens the transportation time of the original document. The time required from transporting, scanning, to discharging the original document may be shortened, improving the performance of the scanning device.

In one embodiment, the first speed may include a first forward speed and a first reverse speed. When the image detection unit 22 detects that the rear end position of the original document reaches the second scanning end position, the control unit 21 may control the motor to transport the original document at the first forward speed. When the rear end position of the original document reaches the first reverse position, the control unit 21 may control the motor to transport the original document at the first reverse speed. The original document may be transported at the first reverse speed continuously until the front end position of the original document reaches the second reverse position, and the control unit 21 may control the motor to switch to the first forward speed to transport the original document.

In one embodiment, the first forward speed may mean that the motor rotates at high speed in the forward direction, and the first reverse speed may mean that the motor rotates at high speed in the reverse direction. That is, the direction in which the motor rotates forward may be regarded as the forward direction (forward rotation direction), the speed generated by the motor rotating forward to drive the original document may be regarded as the forward speed, and the speed generated by the motor rotating in the reverse direction to drive the original document may be regarded as the reverse speed. The first reverse position may be the position where the original document is turned over, and may be also the position where the motor changes from forward operation to reverse operation. The second reverse position may be the position where the motor changes from reverse operation to forward operation, that is, the position of the paper feed roller. The first reverse position may be different from the second reverse position. The second reverse position may be used to indicate the position of the paper feed roller, that is, the paper feed position.

As shown in FIG. 11, the first reverse position may be the the point K, and the second reverse position may be the point E. When the original document initially enters the RADF, the motor may run forward to drive the original document quickly through the points A, B, C, D, E, F, and G at the first forward speed. When scanning the front side of the original document and the front end position b of the original document reaches the point H, the motor may run forward to transport the original document at the second speed. When the rear end position d of the original document reaches the point H, the motor may run forward and transport the original document at the first forward speed to drive the original document through the I and J the points quickly. When the point d of the original document reaches the point K, the motor may change from forward operation to reverse operation at the point K. The flipping unit may flip the original document at the point K. The motor may reversely operate to drive the original document quickly through the point K and the point E at the first reverse speed. When the point b of the original document reaches the point E, the motor may change from reverse operation to forward operation. The forward operation of the motor may drive the original document quickly through the points E, F, and G at the first forward speed.

In one embodiment, the first speed may include a first forward speed and a first reverse speed. When the image detection unit 22 detects that the rear end position of the original document reaches the second scanning end position, the control unit 21 may control the motor to transport the original document at the first forward speed. When the rear end position of the original document reaches the first reverse position, the control unit 21 may control the motor to transport the original document at the first reverse speed, and the flipping unit 23 may flip the original document for the second time. When the image read and detection unit 22 detects that the front end position of the original document reaches the second reverse position, the control unit 21 may transport and discharge the original document at the first forward speed.

As shown in FIG. 11, when scanning the back side of the original document, when the front end position b of the original document reaches the point H, the motor may run forward to transport the original document at the second speed. When the rear end position d of the original document reaches the point H, the motor may run forward and transport the original document at the first forward speed to drive the original document through the I and J the points quickly. When the point d of the original document reaches the point K, the motor may change from forward operation to reverse operation at the point K. The flipping unit may flip the original document at the point K. The motor may reversely operate to drive the original document quickly through the point K and the point E at the first reverse speed. When the point b of the original document reaches the point E, the motor may change from reverse operation to forward operation. The forward operation of the motor may drive the original document quickly through the points E, F, G, H, I, J, and K at the first forward speed, such that the original document is discharged quickly.

In one embodiment, the scanning device may further include a fourth image reading unit 24. The control unit 21 may include a motor 211. The motor 211 may be connected to the image detection unit 22. The fourth image reading unit 24 may be connected to the image detection unit 22. The first speed may include the first forward speed. The image detection unit 22 may send a first forward speed control signal to the motor 211, and send a fourth scan start signal to the fourth image reading unit 24, when it is detected that the front end position reaches the third scanning preset position. The motor 211 may adjust the speed of transporting the original document from the first forward speed to the second speed in response to the first forward speed control signal. The fourth image reading unit 24 may be configured to scan the content of the first side or the second side of the original document in response to the fourth scanning start signal.

In the present embodiment, the motor 211 may be configured to change the speed of transporting the original document from the first forward speed to the second speed in response to the first forward speed control signal; or, in response to the first forward speed control signal, decelerate the speed of transporting the original document from the first forward speed to the second speed. In other words, when scanning any side of the original document, the motor may drive the original document at a low forward speed.

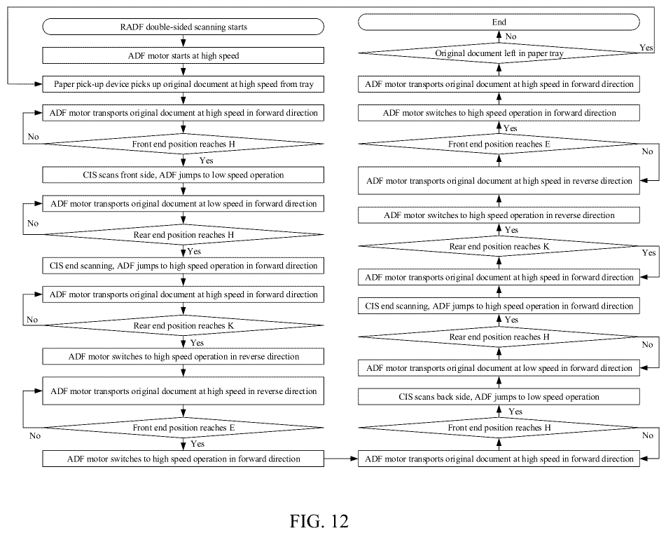

In one embodiment showin in FIG. 12 which is a flowchart of double-sided scanning based on RADF, in conjunction with FIG. 11, the motor 211 may include an ADF motor. When the RADF double-sided scanning is started, the ADF motor may start at the first forward speed which is a high speed, the paper pick-up device may pick up the original document from the paper tray at a high speed, and the ADF motor may rotate forward to transport the original document at the first forward speed which is a high speed. The scanning sensor may determine whether the front end of the original document reaches the point H. When the front end position does not reach the point H, the ADF motor may be controlled continuously to transport the original document at high speed with the first forward speed. When it is detected that the front end position of the original document reaches the point H, the CIS may start scanning the front side of the original document, and the ADF motor may switch to a low speed according to the scanning speed and may keep rotating forward to transport the original document at the second speed. The scanning sensor may determine in real time whether the rear end position of the original document reaches the point H. When the rear end position does not reach the point H, the ADF motor may continue to be controlled to transport the original document at a low speed using the second speed. When the the rear end position reaches the point H, the CIS may end scanning, and the ADF motor may change to high speed operation to transport the original document at the high speed using the first speed. The paper discharge sensor may determine whether the rear end position of the original document reaches the point K. When the rear end position does not reach the point K, the ADF motor may continue to transport the original document at high speed at the first forward speed. When the rear end position reaches the point K, the ADF motor may change from forward operation to reverse operation, run at high speed in the reverse direction to transport the original document at high speed at the first reverse speed, and also turn the original document over. The paper feed sensor may determine whether the front end of the original document reaches the point E. When the front end position does not reach the point E, the ADF motor may continue to transport the original document at high speed at the first reverse speed. When the front end position reaches the point E, the ADF motor may change from reverse operation to forward operation, and transport the original document at high speed at the first forward speed. The scanning sensor may determine whether the front end position of the original document reaches the point H. When the front end position does not reach the point H, the ADF motor may continue to transport the original document at high speed at the first forward speed. When the front end position reaches the point H, the CIS may start to scan the reverse side of the original document, and the ADF motor may change to low speed operation according to the scanning speed and transport the original document at the low speed at the second speed. The scanning sensor may determine whether the rear end position of the original document reaches the point H. When the end position does not reach the point H, the ADF motor may continue to transport the original document at the low speed at the second speed. When the rear end position reaches the point H, the CIS may end scanning, and the ADF motor may change to high-speed operation and transport the original document at high speed at the first forward speed. The paper discharge sensor may determine whether the rear end position of the original document reaches the point K. When the rear end position does not reach the point K, the ADF motor may continue to transport the original document at high speed at the first forward speed. When the rear end position reaches the point K, the ADF motor may change from forward operation to reverse operation, run at high speed in the reverse direction, to transport the original document at high speed at the first reverse speed and turn the original document over. The paper feed sensor determines whether the front end position of the original document reaches the point E. When the front end position does not reach the point E, the ADF motor may continue to transport the original document at high speed at the first reverse speed. When the front end position reaches the point E, the ADF motor changes from reverse operation to forward operation, transport the original document at high speed at the first forward speed until the original document is discharged. The paper pick-up device may determine whether there are original documents left in the paper tray. When there are no original documents, the operation may end. When there are original documents left, the paper pick-up device may continue to pick up the original documents from the paper tray at high speed.

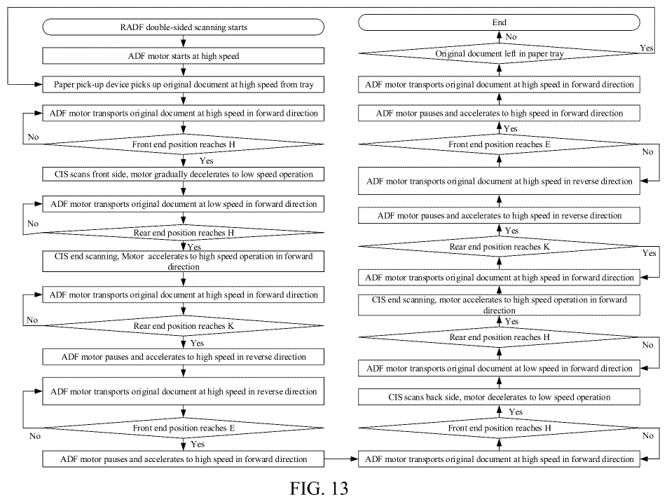

As shown in FIG. 12, the ADF motor may change to low speed operation according to the scanning speed, which means that the ADF motor reduces the speed of transporting the original document directly from the first forward speed to the second speed. The speed of transporting the original document may jump from the first forward speed to the second speed without a deceleration process. In another embodiment shown in FIG. 13 which is a flowchart of another double-sided scanning based on RADF. As shown in FIG. 13, with reference to FIG. 12, the difference between of the FIG. 13 and FIG. 12 is that: as shown in FIG. 13, when the front end position reaches the point H, the ADF motor may decelerate to low-speed operation according to the scanning speed; when the rear end position reaches the point H, the ADF motor may accelerate to high-speed operation; when the rear end position reaches the point K, the ADF motor may first pause and then accelerate in reverse direction to high-speed operation; when the front end position reaches the point E, the ADF motor may first pause and then accelerate to high-speed operation in the forward direction. As shown in FIG. 13, the ADF motor may decelerate to low speed operation according to the scanning speed, which means that the ADF motor may gradually slow down the speed of transporting the original document from the first speed to the second speed, and the speed of the original document may gradually slow down from the first speed to the second speed with a deceleration process.

In one embodiment, the image detection unit 22 may be configured to send a second forward speed control signal to the motor 211 and send a fourth scanning end signal to the fourth image reading unit 24 when detecting that the rear end position reaches the second scanning end position. The motor 211 may respond to the second forward speed control signal and adjust the speed of transporting the original document from the second speed to the first forward speed. The fourth image reading unit 24 may stop scanning the first side content or the second side content of the original document in response to the fourth scanning end signal.

In one embodiment, the motor 211 may change the speed of transporting the original document from the second speed to the first forward speed in response to the second forward speed control signal; or accelerate the speed of transporting the original document from the second speed to the first forward speed in response to the second forward speed control signal.

As shown in FIG. 12, when the rear end position reaches point H, the ADF motor may change to high-speed operation, which means that the ADF motor may directly increase the speed of transporting the original document from the second speed to the first forward speed, and the speed of the original document may jump from the second speed to the first forward speed without an acceleration. In another embodiment shown in FIG. 13, when the rear end position reaches the point H, the ADF motor may accelerate to high-speed operation, which means that the ADF motor may gradually increase the speed of transporting the original document from the second speed to the first forward speed, and the speed of the original document may increase from the second speed to the first forward speed gradually with an acceleration process.

In one embodiment, the image detection unit 22 may send a first reverse speed control signal to the motor 211 when detecting that the rear end position reaches the first reverse position. The motor 211 may change the speed of transporting the original document from the first forward speed to the first reverse speed in response to the first reverse speed control signal.

The motor 211 may respond to the first reverse speed control signal to change the speed of transporting the original document from the first forward speed to the first reverse speed; or, in response to the first reverse speed control signal, pause the operation, and accelerate to the first reverse speed in the reversed direction.

As shown in FIG. 12, when the rear end position reaches the point K, the ADF motor may change from forward operation to reverse operation and operate at high speed in the reverse direction. That is, the ADF motor may change the transport speed from the first forward speed to the first reverse speed directly, such that the speed of the original document is directly converted from the first forward speed to the first reverse speed. In another embodiment, as shown in FIG. 13, when the rear end position reaches the point K, the ADF motor may first pause, and then accelerate in reverse to high-speed operation. That is, the ADF motor may first changes the transportation speed from the first forward speed of forward operation to 0, and then the ADF motor may run in the reverse direction and gradually accelerate the speed from 0 to the first reverse speed, such that the speed of the original document changes from the first forward speed to 0 and then gradually accelerates from 0 to the first reverse speed.

In one embodiment, the image detection unit 22 may send a second reverse speed control signal to the motor 211 when detecting that the front end position reaches the second reverse position. The motor 211 may respond to the second reverse speed control signal by adjusting the speed of transporting the original document from the first reverse speed to the first forward speed.

The motor 211 may change the speed of transporting the original document from the first reverse speed to the first forward speed in response to the second reverse speed control signal; or, in response to the second reverse speed control signal signal, pause the operation, and accelerate forward to the first forward speed.

As shown in FIG. 12, when the front end position reaches the point E, the ADF motor may change from reverse operation to forward operation and operate at high speed in the forward direction. That is, the ADF motor may change the transport speed from the first reverse speed to the first forward speed directly, such that the speed of the original document is directly converted from the first reverse speed to the first forward speed. In another embodiment, as shown in FIG. 13, when the front end position reaches the point E, the ADF motor may first pause, and then accelerate in the forward direction to high-speed operation. That is, the ADF motor may first changes the transportation speed from the first reverse speed of the reverse operation to 0, and then the ADF motor may run in the forward direction and gradually accelerate the speed from 0 to the first forward speed, such that the speed of the original document changes from the first reverse speed to 0 and then gradually accelerates from 0 to the first forward speed.

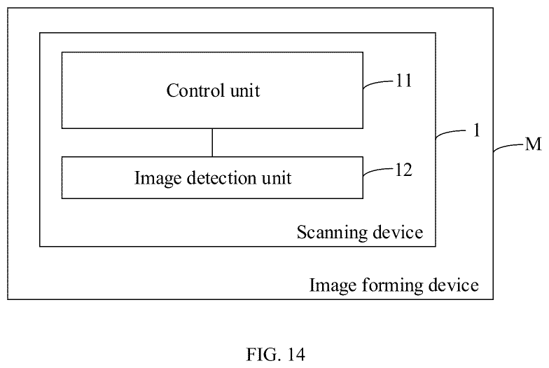

The present disclosure also provides an image forming device. As shown in FIG. 14 which is an schematic diagram of exemplary image forming device provided by the present disclosure, in one embodiment, the image forming device M may include a scanning device 1. The scanning device 1 may include a control unit 11 and an image detection unit 12. The control unit 11 and the image detection unit 12 may be connected to each other.

The control unit 11 may be used to transport the original document at a first speed. The image detection unit 12 may be used to control the control unit 11 to transport the original document at a second speed when detecting that the front end position of the original document reaches the first scanning preset position. The second speed may be less than the first speed. After the scanning is completed, the image detection unit 12 may be also used to control the control unit 11 to transport the original document at the first speed and discharge the original document when detecting that the rear end position of the original document reaches the first scanning end position.

The scanning device 1 further includes a first image reading unit, the first image reading unit is used to scan the original document; when a single-sided scanning mode is activated, the image detection unit sends a first scanning start signal to the first image reading unit when detecting that the front end position of the original document reaches the first scanning preset position; and the first image reading unit is configured to scan a content of the original document at the second speed in response to the first scanning start signal.

The scanning device 1 further includes a second image reading unit and a third image reading unit, the second image reading unit is used to scan a first side of the original document, and the third image reading unit is used to scan a second side of the original document; when a double-sided scanning mode is activated and the image detection unit detects that the front end position of the first side of the original document reaches the first scanning preset position, the second image reading unit scans a content of the first side of the original document at the second speed in response to a second scanning start signal sent by the image detection unit; and when the image detection unit detects that the front end position of the second side of the original document reaches a second scanning preset position, the third image reading unit scans the content of the second side of the original document at the second speed in response to a third scanning start signal sent by the image detection unit. The second image reading unit and the third image reading unit are respectively disposed on the first side and the second side of the original document, and the second image reading unit and the third image reading unit are opposite to each other. The control unit includes a motor, and the motor is connected to the image detection unit; when the image detection unit detects that the front end position of any side of the original document reaches a scanning preset position, the control unit controls the motor to adjust the speed of transporting the original document from the first speed to the second speed in response to a first speed control signal sent by the image detection unit.

In the present disclosure, the image forming device M may include, but is not limited to, a scanner, a printer, or another device with scanning functions. The image forming device M may include any scanning device 1 provided by various embodiments of the present disclosure. For detailed description, references may be made to the embodiments of the scanning device 1 mentioned above.

In the image forming device provided by the present disclosure, the image forming device may includes the scanning device. The scanning device may include the control unit and the image detection unit. The control unit may be used to transport the original document at a first speed. The image detection unit may be used to control the control unit to transport the original document at a second speed when detecting that the front end position of the original document reaches the first scanning preset position. The second speed may be less than the first speed. After the scanning is completed, the image detection unit may be also used to control the control unit to transport the original document at the first speed and discharge the original document when detecting that the rear end position of the original document reaches the first scanning end position. Therefore, the original document may be transported at a low speed when being scanned, ensuring the quality of the scan. The original document may be transported quickly when there is no need to be scanned, increasing the transportation speed of original document and shortening the transportation time of the original document. The time required from transporting, scanning, to discharging the original document may be shortened, improving the performance of the image forming device.

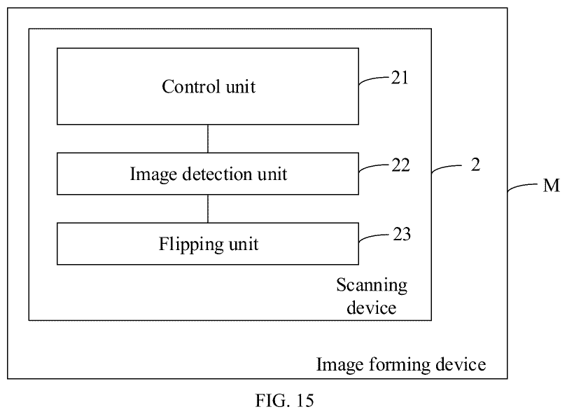

In another embodiment shown in FIG. 15 which is another schematic diagram of exemplary image forming device provided by the present disclosure, the image forming device M may include a scanning device 2. The scanning device 2 may include a control unit 21, an image detection unit 22, and a flipping unit 23.

When the double-sided scanning mode is started, the control unit 21 may be used to transport the original document at a first speed. The image detection unit 22 may be used to control the control unit 21 to transport the original document at a second speed when detecting that the front end position of the original document reaches the third scanning preset position. The second speed may be less than the first speed. After finishing scanning the first side of the original document, the image detection unit 22 may be also used to control the control unit 21 to transport the original document at the first speed when detecting that the rear end position of the original document reaches the second scanning end position, and also control the flipping unit 23 to flip the original document when detecting the front end position reaches the first reverse position. The image detection unit 22 may be used to control the control unit 21 to transport the original document at a second speed when detecting that the front end position of the original document reaches the third scanning preset position; after finishing scanning the second side of the original document, may control the control unit 21 to transport the original document at the first speed when detecting the rear end position reaches the second scanning end position; and control the flipping unit 23 to flip the original document when the rear end position reaches the first reverse position such that a plurality of original documents has continuous page numbers when being discharged.

The first speed includes a first forward speed and a first reverse speed; when the image detection unit detects that the rear end position of any side of the original document reaches the first reverse position, the control unit controls the scanning device to transport the original document at the first reverse speed until the image detection unit detects that the front end position of the side of the original document reaches a second reverse position, and the control unit then controls the scanning device to transport the original document at the first forward speed, wherein the first reverse position and the second reverse position are different.

The original document is transported at the first forward speed from a second reverse position to the third scanning preset position, wherein the second reverse position is different from the third scanning preset position.

The image forming device further includes a fourth image reading unit for scanning the original document, the control unit includes a motor connected to the image detection unit; the first speed includes a first forward speed; when the image detection unit detects the front end position of any side of the original document reaches the third scanning preset position, a first forward speed control signal is sent to the motor, and a fourth scanning start signal is sent to the fourth image reading unit; and the control unit controls the motor to adjust the speed of transporting the original document from the first forward speed to the second speed in response to the first forward speed control signal, and the fourth image reading unit scans the contents of any side of the original document in response to the fourth scanning start signal.

In the present disclosure, the image forming device M may include, but is not limited to, a scanner, a printer, or another device with scanning functions. The image forming device M may include any scanning device 2 provided by various embodiments of the present disclosure. For detailed description, references may be made to the embodiments of the scanning device 2 mentioned above.

In the image forming device provided by the present disclosure, the image forming device may includes the scanning device. The scanning device may include the control unit, the image detection unit and the flipping unit. When the double-sided scanning mode is started, the control unit may be used to transport the original document at a first speed. The image detection unit may be used to control the control unit to transport the original document at a second speed when detecting that the front end position of the original document reaches the third scanning preset position. The second speed may be less than the first speed. After finishing scanning the first side of the original document, the image detection unit may be also used to control the control unit to transport the original document at the first speed when detecting that the rear end position of the original document reaches the second scanning end position, and also control the flipping unit to flip the original document when detecting the front end position reaches the third scanning preset position. The image detection unit may be used to: control the control unit to transport the original document at a second speed when detecting that the front end position of the original document reaches the third scanning preset position; after finishing scanning the second side of the original document, may control the control unit to transport the original document at the first speed when detecting the rear end position reaches the second scanning end position; and control the flipping unit to flip the original document when the rear end position reaches the first reverse position such that a plurality of original documents has continuous page numbers when being discharged. Therefore, the original document may be transported at a low speed when being scanned, ensuring the quality of the scan. The original document may be transported quickly when there is no need to be scanned, increasing the transportation speed of original document and shortening the transportation time of the original document. The time required from transporting, scanning, to discharging the original document may be shortened, improving the performance of the image forming device.

The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. A scanning device, comprising a control unit and an image detection unit, wherein:
the control unit is used to control the scanning device to transport an original document at a first speed;
the image detection unit is used to detect a position where the original document reaches;
when the image detection unit detects that a front end position of the original document reaches a first scanning preset position, the control unit controls the scanning device to transport the original document at a second speed, wherein the second speed is smaller than the first speed; and
after the scanning is completed, when the image detection unit detects that a rear end position of the original document reaches a first scanning end position, the control unit controls the original document to be transported at the first speed and discharged.

2. The device according to claim 1, further including a first image reading unit, wherein:
the first image reading unit is used to scan the original document;
when a single-sided scanning mode is activated, the image detection unit sends a first scanning start signal to the first image reading unit when detecting that the front end position of the original document reaches the first scanning preset position; and
the first image reading unit is configured to scan a content of the original document at the second speed in response to the first scanning start signal.

3. The device according to claim 1, further including a second image reading unit and a third image reading unit, wherein:
the second image reading unit is used to scan a first side of the original document, and the third image reading unit is used to scan a second side of the original document;
when a double-sided scanning mode is activated and the image detection unit detects that the front end position of the first side of the original document reaches the first scanning preset position, the second image reading unit scans a content of the first side of the original document at the second speed in response to a second scanning start signal sent by the image detection unit; and
when the image detection unit detects that the front end position of the second side of the original document reaches a second scanning preset position, the third image reading unit scans the content of the second side of the original document at the second speed in response to a third scanning start signal sent by the image detection unit.

4. The device according to claim 3, wherein:
the second image reading unit and the third image reading unit are respectively disposed on the first side and the second side of the original document, and the second image reading unit and the third image reading unit are opposite to each other.

5. The device according to claim 1, wherein:
the control unit includes a motor, and the motor is connected to the image detection unit;
when the image detection unit detects that the front end position of any side of the original document reaches a scanning preset position, the control unit controls the motor to adjust the speed of transporting the original document from the first speed to the second speed in response to a first speed control signal sent by the image detection unit.

6. A scanning device, comprising a control unit, an image detection unit, and a flipping unit, wherein:
the control unit is used to control the scanning device to transport an original document at a first speed;
the image detection unit is used to detect a position where the original document reaches;
the flipping unit is used to flip the original document when the original document reaches a first reverse position;
when a double-sided scanning mode is activated and the image detection unit detects that a front end position of a first side of the original document reaches a third scanning preset position, the control unit controls the scanning device to transport the first side of the original document at a second speed, wherein the second speed is smaller than the first speed;
after finishing scanning the first side of the original document, when the image detection unit detects a rear end position of the first side of the original document reaches a second scanning end position, the control unit controls the scanning device to transport the first side of the original document at the first speed until detecting that the rear end position of the first side of the original document reaches the first reverse position;
after the flipping unit flips the original document from the first side to the second side, the control unit controls the scanning device to transport the second side of the original document at the first speed until the image detection unit detects that a front end position of the second side of the original document reaches the third scanning preset position, and the control unit controls the scanning device to transport the second side of the original document at the second speed; and
after scanning the second side of the original document is finished, the original document is continuously transported, and, when the image detection unit detects a the rear end position of the second side of the original document reaches the second scanning end position, the control unit controls the scanning device to circulate and transport the original document at the first speed, until it is discharged the original document in a consistent state with the first side of the original document before scanning.

7. The device according to claim 6, wherein:
the first speed includes a first forward speed and a first reverse speed;
when the image detection unit detects that the rear end position of any side of the original document reaches the first reverse position, the control unit controls the scanning device to transport the original document at the first reverse speed until the image detection unit detects that the front end position of the side of the original document reaches a second reverse position, and the control unit then controls the scanning device to transport the original document at the first forward speed, wherein the first reverse position and the second reverse position are different.

8. The device according to claim 7, wherein:
the original document is transported at the first forward speed from a second reverse position to the third scanning preset position, wherein the second reverse position is different from the third scanning preset position.

9. The device according to claim 6, further including a fourth image reading unit for scanning the original document, wherein:
the control unit includes a motor connected to the image detection unit;
the first speed includes a first forward speed;
when the image detection unit detects the front end position of any side of the original document reaches the third scanning preset position, a first forward speed control signal is sent to the motor, and a fourth scanning start signal is sent to the fourth image reading unit; and
the control unit controls the motor to adjust the speed of transporting the original document from the first forward speed to the second speed in response to the first forward speed control signal, and the fourth image reading unit scans the contents of any side of the original document in response to the fourth scanning start signal.

10. An image forming device, comprising a scanning device, wherein:
the scanning device includes a control unit and an image detection unit:
the control unit is used to control the scanning device to transport an original document at a first speed;
the image detection unit is used to detect a position where the original document reaches;
when the image detection unit detects that a front end position of the original document reaches a first scanning preset position, the control unit controls the scanning device to transport the original document at a second speed, wherein the second speed is smaller than the first speed; and
after the scanning is completed, when the image detection unit detects that a rear end position of the original document reaches a first scanning end position, the control unit controls the original document to be transported at the first speed and discharged.

11. The image forming device according to claim 10, further including a first image reading unit, wherein:
the first image reading unit is used to scan the original document;
when a single-sided scanning mode is activated, the image detection unit sends a first scanning start signal to the first image reading unit when detecting that the front end position of the original document reaches the first scanning preset position; and
the first image reading unit is configured to scan a content of the original document at the second speed in response to the first scanning start signal.

12. The image forming device according to claim 10, further including a second image reading unit and a third image reading unit, wherein:
the second image reading unit is used to scan a first side of the original document, and the third image reading unit is used to scan a second side of the original document;
when a double-sided scanning mode is activated and the image detection unit detects that the front end position of the first side of the original document reaches the first scanning preset position, the second image reading unit scans a content of the first side of the original document at the second speed in response to a second scanning start signal sent by the image detection unit; and
when the image detection unit detects that the front end position of the second side of the original document reaches a second scanning preset position, the third image reading unit scans the content of the second side of the original document at the second speed in response to a third scanning start signal sent by the image detection unit.

13. The image forming device according to claim 12, wherein:
the second image reading unit and the third image reading unit are respectively disposed on the first side and the second side of the original document, and the second image reading unit and the third image reading unit are opposite to each other.

14. The image forming device according to claim 10, wherein:
the control unit includes a motor, and the motor is connected to the image detection unit;
when the image detection unit detects that the front end position of any side of the original document reaches a scanning preset position, the control unit controls the motor to adjust the speed of transporting the original document from the first speed to the second speed in response to a first speed control signal sent by the image detection unit.

15. The image forming device according to claim 10, further including a flipping unit, wherein:
the flipping unit is used to flip the original document when the original document reaches a first reverse position;
when a double-sided scanning mode is activated and the image detection unit detects that a front end position of a first side of the original document reaches a third scanning preset position, the control unit controls the scanning device to transport the first side of the original document at a second speed, wherein the second speed is smaller than the first speed;
after finishing scanning the first side of the original document, when the image detection unit detects a rear end position of the first side of the original document reaches a second scanning end position, the control unit controls the scanning device to transport the first side of the original document at the first speed until detecting that the rear end position of the first side of the original document reaches the first reverse position;
after the flipping unit flips the original document from the first side to the second side, the control unit controls the scanning device to transport the second side of the original document at the first speed until the image detection unit detects that a front end position of the second side of the original document reaches the third scanning preset position, and the control unit controls the scanning device to transport the second side of the original document at the second speed; and
after scanning the second side of the original document is finished, the original document is continuously transported, and, when the image detection unit detects a the rear end position of the second side of the original document reaches the second scanning end position, the control unit controls the scanning device to circulate and transport the original document at the first speed, until it is discharged the original document in a consistent state with the first side of the original document before scanning.

16. The image forming device according to claim 15, wherein:
the first speed includes a first forward speed and a first reverse speed;
when the image detection unit detects that the rear end position of any side of the original document reaches the first reverse position, the control unit controls the scanning device to transport the original document at the first reverse speed until the image detection unit detects that the front end position of the side of the original document reaches a second reverse position, and the control unit then controls the scanning device to transport the original document at the first forward speed, wherein the first reverse position and the second reverse position are different.

17. The image forming device according to claim 16, wherein:
the original document is transported at the first forward speed from a second reverse position to the third scanning preset position, wherein the second reverse position is different from the third scanning preset position.

18. The image forming device according to claim 15, further including a fourth image reading unit for scanning the original document, wherein:
the control unit includes a motor connected to the image detection unit;
the first speed includes a first forward speed;
when the image detection unit detects the front end position of any side of the original document reaches the third scanning preset position, a first forward speed control signal is sent to the motor, and a fourth scanning start signal is sent to the fourth image reading unit; and
the control unit controls the motor to adjust the speed of transporting the original document from the first forward speed to the second speed in response to the first forward speed control signal, and the fourth image reading unit scans the contents of any side of the original document in response to the fourth scanning start signal.
